(19) United States
(12) Patent Application Publication
(10) Pub. No.: US 2023/0249256 A1
(43) Pub. Date: Aug. 10, 2023

(54) POWDER-BED BASED ADDITIVE MANUFACTURING METHOD

(71) Applicant: Safran Aircraft Engines, Paris (FR)

(72) Inventor: Hugo Jean-Louis SISTACH, MOISSY-CRAMAYEL (FR)

(73) Assignee: Safran Aircraft Engines, Paris (FR)

(21) Appl. No.: 18/012,521

(22) PCT Filed: Jun. 23, 2021
(86) PCT No.: PCT/FR2021/051147

§ 371 Date: Dec. 22, 2022

(30) Foreign Application Priority Data
Jun. 23, 2020 (FR) FR2006562

(51) Int. Cl. B22F 10/73; B22F 10/28; B22F 10/85; B33Y 10/00; B33Y 50/02; B33Y 40/00; B33Y 30/00; B22F 12/90

(52) U.S. Cl. CPC B22F 10/73; B22F 10/28; B22F 10/85; B33Y 10/00; B33Y 50/02; B33Y 40/00; B33Y 30/00; B22F 12/90; B22F 2998/10

(57) ABSTRACT

The manufacturing method comprises the following steps: —extracting a sub-batch (18) from a batch (16) of powder, the batch having a ratio X₀ of a predetermined component, —manufacturing parts (22) using powder-bed based additive manufacturing until all of the sub-batch is used up (18); then—performing the following cycle a number nₘₐₓ of times: —recycling the powder and continuing manufacture until all of the recycled powder is used up; —determining a contact surface Sₙ between the powder and a material fused into the parts (22), n designating the cycle number, and a mass Mₙ of accumulated powder used since the start of the method, and—measuring a ratio Xₙₘₐₓ of a predetermined component in at least one of the parts (22) or a test piece (24) manufactured during the last cycle, then—determining a quantity R such that: Formula (I); —performing the following cycle at least once: —recycling the powder and continuing manufacture until all of the recycled powder has been used up at least once, then—determining the contact surface Sₙ, and the mass Mₙ of accumulated powder, and—calculating, by means of Sₙ, Mₙ and R, a ratio Xₙ of the component in one of the parts (22) manufactured during the cycle.

### FIELD OF THE INVENTION

The invention relates to the additive manufacturing of parts, for example aeronautical parts, by powder-bed fusion.

### PRIOR ART

Laser powder-bed fusion is a metallic additive manufacturing method which consists of creating a part, layer-by-layer, through the fusion of powder particles by means of a laser beam. This technology is also known as Selective Laser Melting (SLM). It enables the manufacture of parts with geometries that cannot be produced using conventional methods. The laser beam can be replaced by an electron beam.

The method is implemented in an enclosure under inert gas. It can be described in four steps:
once the powder is stored in a supply tank, a piston raises the tank to the height of one layer thickness;
a layering member spreads a layer of powder of this thickness in a printing tray.

This is the powder bed;
if the layering is valid, a laser passes through the layer and gives rise to a first section of the object by creating micro-cords next to one another originating from the fusion of the powder particles located on its path. If the layer formed is not uniform, a second layering is carried out in order to fill the gaps before the passage of the laser;
finally, the printing tray is slightly lowered (by the thickness of one layer of powder) and the operation recommences. In this way, the particles will fuse, layer by layer, until the finished part is obtained.

Once the part is finished, the powder which has been installed but which has not being used to produce the part, is recovered. It can then be recycled in order to manufacture a new part, and this can be done several times in a row. In this way, significant powder savings are produced.

However, it is observed that the chemical composition of the manufactured parts changes over the course of recycling of the powder. This concerns, in particular, their oxygen, nitrogen and hydrogen content.

However, the content of these elements in the parts has an impact on the properties of the material, in particular the mechanical tensile and fatigue properties. It is therefore important to know, or even to control, this content in order to ensure the conformity of the parts with the basic composition of the material and hence their behaviour in operation.

To this end, the overall elementary chemical composition of a portion or a part that can be destroyed, or of an adjoining test piece having a representative composition, can be analysed in order to check its conformity with respect to the basic composition. An overall chemical analysis is therefore carried out for each manufacture. However, this creates significant delay, which blocks the delivery of the parts. The cost is high and is often incompatible with the expected profitability. Moreover, it involves either destroying a part for the analysis, or manufacturing a test piece, which leads to additional fusion time and consumes powder, therefore increasing the cost. It is therefore a long and expensive analysis.

Of course a maximum number of recycling operations can be defined, in other words a limit to the number of uses of the unfused powder, ensuring that any change in the chemical composition is not so large that it becomes non-conforming. This solution can be implemented after having carried out a chemical analysis over several recycling operations, in order to check that the limits of the base composition of the material associated with a machine type and a given fixed production are not exceeded. However, this is expensive. Its implementation depends each time on the manufacturing facility and the parts produced. Moreover, once the maximum number of powder recycling operations has been reached, the powder must be completely discarded, which again leads to a loss of material. However, the maximum number of recycling operations is in general not very high, being for example 5. This solution thus leads to the discarding of powder which could yet be potentially acceptable for a new manufacture of less demanding parts. In addition, the chemical composition analyses to be carried out remain numerous and are thus, all told, expensive. An object of the invention is to promote the conformity of manufactured parts with the properties expected of them, by means of an inexpensive and powder-saving solution.

### DISCLOSURE OF THE INVENTION

To this effect, the invention relates to a manufacturing method comprising the following steps:
extracting a sub-batch from a batch of powder, the batch having a content X₀ of a predetermined compound,
by means of the sub-batch, manufacturing parts by powder-bed based additive manufacturing until all of the sub-batch has been used; then
carrying out the following cycle a number nₘₐₓ of times:
   recycling the powder from the manufacture and continuing the manufacture until all of the recycled powder has been used;
   determining:
   a contact area Sₙ between the powder and a fused material in the parts, accumulated from the start of the method, n designating a number of the cycle, and
   a mass Mₙ of accumulated powder used since the start of the method, the recycled powder at each cycle counting as additional mass, and
measuring a content Xₙₘₐₓ of the compound in at least one of the parts manufactured during the last cycle or a test piece manufactured during the last cycle, then
calculating a quantity R such as:

$${X}_{nmax} = {X}_{0} + R * {\sum }_{n = 1}^{n = nmax} \frac{Sn}{Mn}$$

carrying out the following cycle at least once:
   recycling the powder and continuing the manufacture until at least all of the recycled powder has been used at least once, then
   determining the contact area Sₙ and the mass Mₙ of powder, and
   calculating, using Sₙ, Mₙ and R, a content Xₙ of the compound in one of the parts manufactured during the cycle.

The invention therefore makes it possible to estimate the content Xₙ in the parts over the course of the manufacturing cycles.

The theoretical principle of the method is that, during the fusion of the part, in a given layer, the powder located close to the melt rises in temperature. This increase promotes a change in the content of certain elements in the powder, in particular oxygen, nitrogen and hydrogen.

Once the manufacture is achieved, the recycling operation (by suction, sieving and mixing) homogenises the distribution of the composition of the powder by diluting, in the remainder of the powder, the powder which was close to the melts and for which the composition has changed. This makes the overall change in the composition of the powder uniform.

It is therefore possible to experimentally link the change in the composition to the quantity of powder which is heated by the melt. This quantity may be linked to the contact area between the powder and the fused part in each layer (i.e. the surface area of the part, excluding the upper and lower surface). A law is proposed in order to link these quantities and to predict the chemical composition after each manufacture and after a plurality of manufactures.

The proposed methodology associated with the law enables predictive monitoring of the chemical composition via the definition of the parameters of the law, knowledge of the initial composition of the powder, stability of the manufacturing method and the collection of simple manufacturing data.

The method of the invention enables monitoring of the chemical composition of the manufactured parts, which is fast, or even instantaneous, low-cost, non-destructive, and without risk to the conformity of the parts, and reusing the powder as much as possible in order to limit the quantity that is discarded, while facilitating the management of the powder, for example at the time of mixing the powders during recycling operations.

It is possible that the batch is new at the start of the implementation of the method.

The method is particularly applicable when the compound is oxygen, hydrogen or nitrogen, but it is possible to implement it for other compounds.

It is possible that the method then comprises the following steps:
determining whether the content X, fulfils a predetermined condition, and
determining a follow-up to be applied to the method according to whether or not the content fulfils the condition.

In an embodiment, the method comprises the following steps:
extracting another sub-batch from the batch of powder;
producing a mixture of the other sub-batch with the powder from the manufacture; and
repeating the manufacture with the mixture.

Thus, the operation makes it possible to “refresh” the powder originating from the manufacture, in which the content of the compound has changed, with the powder originating from the batch. At the end of mixing, the content of the mixture is equal to the weighted sum of the contents.

Alternatively, the powder can be refreshed with powder which is not new and which has also itself already been used for additive manufacturing, provided that a good estimate of its content is available. Indeed, during such a mixture of sub-batches of powder having had different uses, originating from the same initial batch, the final content final is also the average of the contents for the chemical composition of the two sub-batches, weighted by the mass.

It is thus possible to add powder that is not very recycled, or even new, to a sub-batch having already undergone a plurality of recycling operations.

It is possible to carry out the three above-mentioned steps associated with the mixture when the condition is not fulfilled.

Hence, the mixing is carried out, i.e. the powder is refreshed, when it is determined that this refreshing is necessary.

Alternatively, it is possible that these three steps are carried out without determining beforehand whether the content X, fulfils a predetermined condition. Hence, this time, the refreshing is carried out anyway. It is possible, for example, that the refreshing is carried out systematically once all the powder has been used during the manufacture, for example in order to conserve a constant content for the compound.

In an embodiment:
during at least some of the cycles, a content X_{n,mes} of the compound is measured in at least one of the parts during the cycle, in a test piece manufactured during the cycle or in the powder used during the cycle,
a standard deviation of the content X_{n,mes} is determined, and
during at least some of the cycles after the step of calculating R, it is determined whether the calculated content Xₙ satisfies a predetermined condition relating to the standard deviation.

These steps form a test which can verify whether the estimated content Xₙ remains credible.

For example, it is determined whether:

|Xₙ−X_{n,moy}|=<2×σ

where:
X_{n,moy} designates an average of the content Xₙ from a plurality of cycles, and
6 is the standard deviation of the contents X_{n,mes}.

The invention also relates to a facility for powder-bed based additive manufacturing, comprising:
means for powder-bed based additive manufacturing, and
a control member configured to control the execution of the method according to the invention.

The invention also relates to a computer program comprising code instructions designed to control the execution of the method of the invention when it is used on a computer, a data recording medium comprising such a program in recorded form, and a method for providing such a program on a telecommunications network for the purpose of downloading it or executing it remotely.

### DESCRIPTION OF THE FIGURES

An embodiment of the invention will now be described by way of a non-limiting example with support of the drawings, in which:

FIG. 1 is a schematic diagram of the increase in temperature of the powder and of the diffusion of oxygen in the powder;

FIG. 2 is a graph showing the change in oxygen content as a function of the number of recycling operations;

FIG. 3 is a schematic diagram of the increase in oxygen content in the powder after a manufacture;

FIG. 4 is a schematic diagram of the chemical composition in oxygen, of a sample from the batch of powder after recycling;

FIG. 5 is a schematic representation of the quantities of the recycling law;

FIG. 6 is a schematic representation of the oxygen-capturing regions of powder and of the regions not capturing oxygen in the recycling law;

FIG. 7 is a schematic representation of the quantities Sn, Pn and An; and

FIG. 8 is a diagram showing a facility according to the invention.

The theoretical basis of the invention will now be described, followed by the progress of the implementation of the method of the invention.

The following definitions are proposed:
manufacturing or construction cycle: all of the steps for producing a part or an article, starting with the spreading of the first layer and finishing with the fusion of the last layer;
manufacturing campaign: all of the manufacturing cycles consisting of manufacturing parts or articles using the same sub-batch of powder once; it also involves a cycle, thus grouping together a plurality of manufacturing cycles.
recycling: operation consisting of discharging the powder from the facility, re-sieving it, optionally baking it, reconditioning it and then reusing it.

Here, it is assumed that the manufacture is carried out by means of a laser beam, but the present description is also valid for an electron beam.

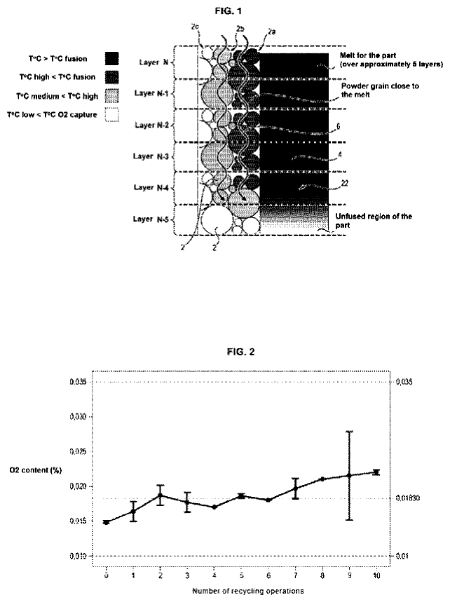

With reference to FIG. 1, the method uses a metal alloy powder that is known per se. The grains 2 of this powder comprise, in addition to one or more metals, elements such as oxygen, nitrogen and hydrogen.

During the additive manufacturing of a part 22 by powder-bed fusion, layers of metal powder N, N-1, N-2, N-3, N-4, N-5 are stacked on one another. After the positioning of each layer, the laser beam passes through one or more layers of powder in order to fuse some of the grains of powder in order to construct the part 22. The portion 4 fused in this way is illustrated on the right-hand side of FIG. 1. More precisely, during the treatment of each layer by the laser, several adjacent layers are simultaneously re-fused. In the figure, it is shown that the five upper layers have been re-fused in contrast to the lowest layer, N-5, which is not.

The non-fused grains 2 of powder are located on the left-hand side. Some of these grains may however be heated, in particular those which are located in direct proximity to the fused grains. The figure thus shows different levels of heating of the grains 2a, 2b, 2c depending on their decreasing proximity to the fused portion 4, with temperatures indicated as high, medium and low respectively, without however exceeding the melting temperature.

However, this heating changes some elements of the grains, in particular oxygen, nitrogen and hydrogen. This occurs by introducing additional elements into the powder from the atmosphere of the manufacturing enclosure. This addition is illustrated in the figure by the arrows 6. This atmosphere comprises, in particular, air and moisture which penetrate between the grains of powder 2 and lead to the above-mentioned change in the event of heating.

This change is visible during successive recycling operations of the powder and can modify the chemical composition of the fused material (and thus the parts) to the extent of making them non-conforming after a plurality of recycling operations of the powder. This can lead to parts, the material of which has non-conforming properties, in particular tensile and fatigue properties, and which must therefore be discarded.

FIG. 2 shows the change in the oxygen content in the parts as a function of the number of recycling operations of the powder. In this example, it can be seen that an initial oxygen content of 0.015% in the parts manufactured with the new powder, becomes a content which can increase up to more than 0.022% after 10 recycling operations. The present description mainly concerns oxygen; however, the invention is also applicable to nitrogen, hydrogen or any other element modified during the recycling operation.

The invention aims to monitor the change in the chemical composition of the parts in order to ensure their conformity with the expected properties.

A methodology is adopted here which makes it possible to monitor the chemical composition of the powder and the parts, which is fast, or even instantaneous, low cost, non-destructive, inexpensive to develop, which ensures the conformity of the parts without risk, which uses as much of the powder as possible in manufacture, limits the quantity discarded and facilitates the management of the powder, enabling for example the mixing of powders during recycling operations.

As stated above, study of the general method of powder-bed fusion has made it possible to put forward parameters influencing the change in the chemical composition of the elements of the powder during successive recycling operations. It has been possible to determine that the mechanism associated with this change is the capture or evaporation of elements due to local heating of the powder during the manufacture.

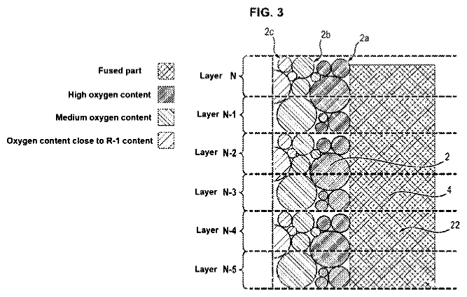

From this study, it has been determined that there is a local change in the composition of the non-fused powder at each manufacture, as a function of the distance to the fused region, as presented in FIG. 3 for oxygen. This figure illustrates the principle of the increase in the oxygen content in the powder after a manufacture.

Thus, it is observed that the grains 2a which are located in the region closest to the fused portion 4 have a relatively high oxygen content. This content decrease in the next region, in other words further to the left in the figure, in order to move to an average content by comparison in the grains 2b. In the other grains 2c, which are located further to the left, the oxygen content is close to that of the powder before this recycling.

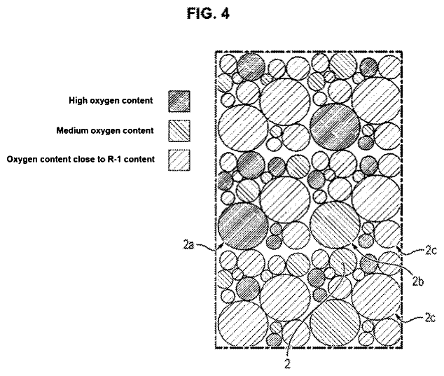

Starting from such a situation, at the end of manufacture of the part, the non-fused powder is recovered and mixed according to validated procedures which ensure a homogeneous mixture. The grains 2a, 2b, 2c with different chemical compositions are therefore mixed together in order to give the configuration of FIG. 4 which illustrates the distribution of grains and their oxygen contents in a sample of powder during the recycling.

This is the mixture used for the subsequent manufacture of a new part. During this manufacture, this mixture is fused in the regions of the part affected by the laser beam. The fusion of grains leads to a part for which the oxygen content is equal to the average of the oxygen content of the grains. A homogenisation is therefore produced in the melt which gives a chemical composition equivalent to the average composition weighted by the mass of the grains of fused powder.

The manufacturing facility 10, which is described in more detail below, comprises a manufacturing tray on which the layers of powder for the manufacture of each part are deposited. It comprises a production tank into which the powder and spatterings fall during this manufacture. It comprises a recovery tank into which, after each manufacture of a part, the unfused powder and the spatterings are poured. Finally, it comprises a sieve through which the content of the recovery tank is passed to be recycled when appropriate.

The following traceability references are set:
Cₙ: Reference for the manufacturing campaign number n which is incremented from the first use of the powder;
C′_{n,y}: Manufacturing or construction cycle reference; and
Rₙ: Reference for the number n of recycling operations of the powder;

The following n variables are set:
Hₙ: Accumulated height (in m) of the construction cycles of a manufacturing campaign n;
Pₙ: Contact perimeter (in m) between the powder and the fused material of the construction cycles of a manufacturing campaign n averaged by the height;
Sₙ: Contact surface area (in m²) between the powder and the fused material, accumulated over the construction cycles of a manufacturing campaign n;
VMₙ: Accumulated volume (in m³) of fused (constructed) parts from a manufacturing campaign n;
VDₙ: Accumulated volume (in m³) of powder deposited on the manufacturing tray or in the recovery tank of a manufacturing campaign n;
Aₙ: Area (cross-section, in m²) in a plane (in general horizontal, XY) perpendicular to the direction of construction of the parts produced during the construction cycles of a manufacturing campaign n, averaged by height;
Xₙ: Overall average oxygen content (in % by mass) of the powder recovered at the end of a manufacturing campaign n, after recycling and mixing;
ΔX_{0→n}: Increase in the oxygen content (in % by mass) between the supplied powder and the end of the manufacturing campaign n (recycling operation n). X₀ corresponds to recycling operation 0, in other words to the starting situation without recycling;
ΔX_{n-1-<n-1: Increase in the oxygen content (in % by mass) between the powder from recycling operation n-}1 and that from recycling operation n;
Mₙ: Accumulated mass of powder (in g) from the construction cycles of a manufacturing campaign n recovered after recycling, including the powder from the production tank and from the recovery tank;
MMₙ: Mass (in g) of fused parts (fused material) from a manufacturing campaign n;
MDₙ: Mass (in g) of powder deposited on the manufacturing tray or in the recovery tank of a manufacturing campaign n;
MPₙ: Mass (in g) of powder and spatterings which are recovered in the sieve during recycling;
MCₙ: Mass of powder (in g) recovered at the end of a manufacturing campaign n after recycling, which has been heated during the fusion of the part and which has captured oxygen;
MFₙ: Mass of powder (in g) recovered at the end of a manufacturing campaign n after recycling, which has not been heated during the fusion of the part and which has not captured oxygen;
XCₙ: Oxygen content (in % by mass) of the powder recovered the end of a manufacturing campaign n after recycling, which has been heated during the fusion of the part and which has captured oxygen;
XFₙ: Oxygen content (in % by mass) of the powder recovered at the end of a manufacturing campaign n after recycling, which has not been heated during the melting of the part and which has not captured oxygen; and
TRₙ: Rate of regeneration (in %) of a manufacturing campaign n (if this rate is fixed over the entire campaign).

The following constants are set:
ΔX_{machine}: Standard increase in oxygen (constant, in % by mass) per unit of heated powder for a specific machine associated with a set of parameters and a version of the control program of the machine;
AP: Area (cross-section, in m²) of the manufacturing tray;
PP: Average percentage of powder and spatterings by volume of fused part which will be recovered by the sieve during the recycling;
e: Thickness (in m) of powder, from the surface of the fused part which is heated and which captures oxygen;
ρₚ: Packed density (in g/m³) of the powder deposited on the manufacturing tray; and
ρₘ: Density (in g/m³) of fused material.

The following diagrams can better represent the various values that are sat in order to express the recycling law. Thus:

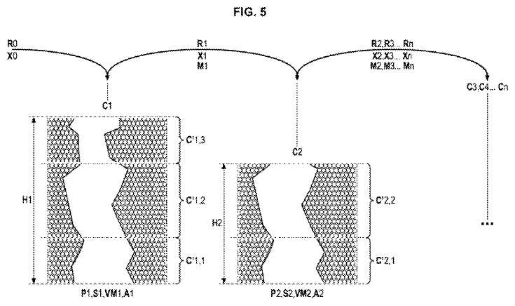

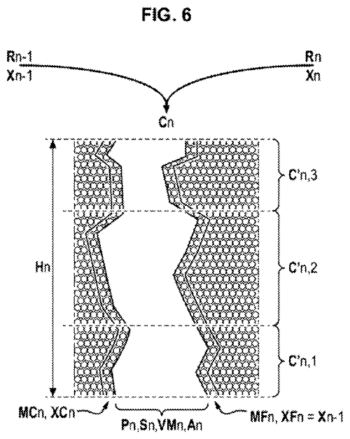

FIG. 5 is a diagram representing quantities of the recycling law;

FIG. 1 is a schematic representation of the oxygen-capturing regions of powder and the regions not capturing oxygen in the recycling law; and

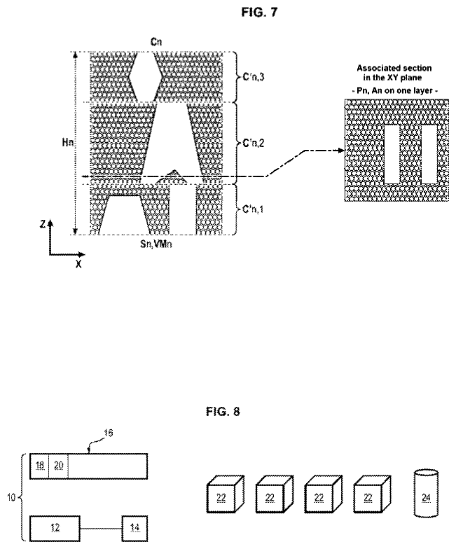

FIG. 7 is a schematic representation of the quantities Sₙ, Pₐ and Aₙ.

The above-mentioned quantities have the following relationships.

The contact area depends on the contact perimeter averaged by the height and the construction height:

Sₙ=Pₙ*Hₙ

The volume de fused parts depends on the area averaged by the height and the construction height:

VMₙ=Aₙ*Hₙ

The volume of powder deposited depends on the area (cross-section) of the construction tray, on the regeneration and on the construction height. For a constant regeneration over the entire campaign n:

VDₙ=AP*TRₙ*Hₙ

The powder which does not capture oxygen therefore has the oxygen content of the preceding recycling operation:

XFₙ=Xₙ₋₁

The content oxygen of the powder at recycling operation n is equal to the weight by mass of the oxygen content of the heated and non-heated powder:

$${X}_{n} = {XF}_{n} * \frac{MFn}{Mn} + {XC}_{n} * \frac{MCn}{Mn} \\ \text{<=>} {X}_{n} = {X}_{n - 1} * \frac{MFn}{Mn} + {XC}_{n} * \frac{MCn}{Mn} , since {XF}_{n} = {X}_{n - 1}$$

The increase in the oxygen content between powder recycling operations n and n−1 is:

ΔX_{n-1→n}=Xₙ−Xₙ₋₁

The increase in the oxygen content between the supplied powder and the recycling operation nmax is the sum of all the increases of recycling operations 0 to nmax:

$$Δ {X}_{0 \to nmax} = {X}_{nmax} - {X}_{0} = {X}_{nmax} + ( - {X}_{nmax - 1} + {X}_{nmax - 1} - ⋯ - {X}_{1} + {X}_{0} ) - {X}_{0} \text{<=>} Δ {X}_{0 \to nmax} = ( {X}_{nmax} - {X}_{nmax - 1} ) + ( {X}_{nmax - 1} - ⋯ - {X}_{1} ) + ( {X}_{1} - {X}_{0} ) = {\sum }_{n = 1}^{n = nmax} ( {X}_{n} - {X}_{n - 1} ) \text{<=>} Δ {X}_{o \to nmax} = {\sum }_{n = 1}^{n = nmax} Δ {X}_{n - 1 \to n}$$

The average standard increase in oxygen per unit volume is constant for a given machine (adjustment of machine parameters, machine program, protective gas) and is equal to the difference between the content before and after heating of the powder and thus between the regions of heated and non-heated powder:

ΔX_{machine}=XCₙ−XFₙ,sinceXFₙ=Xₙ₋₁

<=>ΔX_{machine}=XCₙ−Xₙ₋₁

The total mass after recycling is the sum of the heated and non-heated powder mass recovered after recycling:

Mₙ=MCₙ+MFₙ

The mass of heated powder depends on the density of packed powder associated with the thickness of heated powder and with the contact area (volume of heated powder):

MCₙ=ρₚ*e*Sn

The mass of powder of the recycling operation n is equal to the mass of powder deposited minus the mass of powder which has been fused (and thus not recycled because it is incorporated in the part) minus the mass of powder which will be lost during recycling (spatterings and large powders rejected during sieving or in the ash pan):

Mₙ=MDₙ−MMₙ−MPₙ

The mass of the constructed part depends on the volume of the parts and on the density of the fused material:

MMₙ=ρₘ*VMn

The mass of powder deposited in the machine depends on the volume of powder deposited and on the density of the packed powder:

MDₙ=ρₚ*VDn

The mass of powder lost during the recycling operation depends mainly on the spatterings, the percentage of which depends on the volume of the fused part:

MPₙ=ρₚ*PP*VMn

These relations can be used to deduce a law which makes it possible to predict the oxygen content Xₙ as a function of the manufacturings. Law (I) describes the change between manufacture n−1 and n, while law (II) describes the change based on the initial oxygen content X₀ over a plurality of manufacturings, summed for the total number of recycling operations nₘₐₓ:

$$\begin{matrix}Δ {X}_{n - 1 \to n} = R * \frac{Sn}{Mn} = f ( Mn ; {S}_{n} ; Δ {X}_{machine} ) \\ with R = {ρ}_{p} * e * Δ {X}_{machine} & ( I ) \\ {X}_{nmax} = {X}_{0} + R * {\sum }_{n = 1}^{n = nmax} \frac{Sn}{Mn} & ( II )\end{matrix}$$

These laws make it possible to predict the change in the oxygen composition of the grains and parts. They make it possible to implement the method of the invention, as will be explained for example with the support of FIG. 8.

This method is implemented by means of a facility for powder-bed based additive manufacturing 10 comprising:
means 12 forming a machine for powder-bed based additive manufacturing and
a control member 14 configured to control the execution of the method.

The machine is conventional and will not be described in detail.

The member 14 comprises a computer associated with a program comprising code instructions designed to control the execution of the method when it is used on the computer. This program is recorded on a data recording medium. The program can be made available on an internal or external telecommunications network, such as the Internet, so that it can be downloaded onto the machine or executed remotely.

It is assumed that the facility 12 is stable with regard to the manufacturing parameters such as power, speed of movement of the energy beam and protective atmosphere. For this atmosphere, the parameters are for example the moisture, oxygen, nitrogen and argon contents of the protective gas or of the gas flow in the manufacturing enclosure.

Here, the method steps are as follows.

Initiation Phase

A new batch of metal powder 16 is deposited, having an initial oxygen content X₀. This information may appear among the data communicated by the powder supplier, for example in the supply certificate. It is desirable to know X₀ to a sufficient number of significant figures.

This initial phase aims to determine the constant R of formula (II) for the facility and the manufacturing parameters.

A sub-batch 18 is extracted from the batch of powder 16.

Using the sub-batch 18, the facility manufactures parts 22 by powder-bed based additive manufacturing, and does so until all of the sub-batch 18 has been used. This means that all of the powder of the sub-batch is passed into the facility. The non-fused powder is recovered. This is the first campaign.

Then, the next cycle is carried out, here referred to as the initiation cycle, a number nₘₐₓ of times, for example 10 times, this number not being limiting (it can be replaced by 5, 15, etc.). This cycle is a production campaign.

1) The powder coming from the preceding manufacturing campaign is recycled. This is the powder which has not been consumed in order to form the parts and which can therefore be recovered after each manufacture.

2) The manufacture of the parts 22 continues until all of the recycled powder because been used. During this step, a plurality of test pieces 24 are also manufactured.

3) During this cycle, the contact area S, and the mass M, are determined.

4) A content Xₙ of the compound is calculated on the basis of the surface area Sₙ and the mass Mₙ.

5) A content X_{n,mes} of oxygen in the test piece 24 is measured. This measurement is carried out, for example, twice. An alternative consists of carrying out this measurement on one of the parts 22, but that generally involves destroying the part. Alternatively or in addition, it is possible to carry out the measurement on a sample of the powder used during the cycle.

This cycle ends here.

Thus this cycle is reproduced by the number of time, nₘₐₓ. This leads in particular to manufacturing nₘₐₓ groups of parts 22.

There is therefore a set of measured contents X_{n,mes}, and a mean and standard deviation of these contents X_{n,mes} can be calculated.

The measured contents X_{n,mes} include in particular, an oxygen content Xₙₘₐₓ measured in the test piece 24 manufactured during the last cycle.

The quantity R is then determined by means of formula (II). More precisely, once the data Xn, Sn and Mn are obtained, the graph of the law according to formula (II) can be drawn. From the equation for the curve and after having verified that the calculated value for R is acceptable and that Xₙₘₐₓ is coherent with X₀, the coefficient R is validated.

Thus the initiation phase ends.

Operating Phase

For the remainder of the implementation of the method, R being henceforth known, it is possible to predict or estimate each Xₙ of the following manufacturing campaigns through use of formula (I).

A plurality of new production campaigns are thus carried out, as follows.

The following cycle, referred to as the operating cycle, is carried out at least once. This cycle is also a production campaign.

1) The powder which has not been consumed in the preceding manufacturing campaign is recycled and the manufacture continues until all of the recycled powder has been used at least once.

2) The accumulated contact area Sₙ and mass Mₙ of powder is determined.

3) Using Sₙ, Mₙ and R, the oxygen content Xₙ in one of the parts 22 manufactured during this cycle is calculated. This calculation takes place using formula (I). It involves a predicted or estimated content.

4) It is determined whether this content Xₙ fulfils a predetermined condition. In this case, it is determined whether the calculated content Xₙ satisfies a predetermined condition relating to the standard deviation of the contents X_{n,mes}. For example, it is determined whether:

|Xₙ−X_{n,moy}|=<2×σ (III)

where:
X_{n,moy} designates an average of the content Xₙ of the preceding campaigns, and
σ is the standard deviation.

In other words, a predictive map is established using the law enabling the chemical composition to be predicted after each manufacture. Then, the conformity of the predicted content is checked with a margin of +/−2 standard deviations over the average proposed by the law.

5) Next, a follow-up to be applied to the method Is determined, depending on whether or not the content fulfils the condition (III).

If condition (III) is satisfied, the operating cycle is ended and resumed at the beginning in order to perform a new campaign with the remaining powder (recycling of the remaining powder, manufacture, etc.).

If the condition is not satisfied, another sub-batch 20 is extracted from the batch of powder 16. This other sub-batch 20 is mixed with the powder originating from the manufacture. In order to do this, the following law of mixtures is used in order to obtain a mixture having an acceptable oxygen content, on the basis of the content T₀ of the new sub-batch 20 and the content Xₙ of the remaining powder, and their respective powder masses.

Indeed, the content Xₘᵢₓₜᵤᵣₑ of a mixture of powders with different contents can be determined. It is assumed that the contents X₁ and X₂ of the two powder fractions to be mixed are known. These fractions are weighed in order to know their respective masses M₁ and M₂. The mass Mₘᵢₓₜᵤᵣₑ of the mixture will be the sum of these two masses. The powders are mixed according to a procedure which ensures the homogeneity of the final mixture. The oxygen content in the mixture is calculated by the following weighting formula:

$${X}_{mixture} = \frac{( X 1 * M 1 ) + ( X 2 * M 2 )}{Mmixture}$$

A new operating cycle is then started with the powder mixture obtained in this way. The powder coming from the preceding campaign has thus been refreshed.

A number of operating cycles can thus be carried out. Each time that this appears necessary, the powder remaining after use at the end of the cycle is mixed with the new sub-batch from the batch 16. This can be continued until the batch 16 is used up.

In another embodiment, the remaining powder is mixed at the end of each cycle with a new sub-batch in order to maintain a constant content at the start of each cycle. Therefore, the mixing step is carried out without determining beforehand whether the content Xₙ fulfils the condition (III) or again the mixing step is carried out even if the condition is fulfilled.

It can therefore be seen that the prediction of Xₙ makes it possible to refresh the used powder with a new powder in order to adjust its chemical composition and to readjust to within the chemical composition limits of the criteria when it is too close to the criterion limit. Alternatively, it also allows continuous refreshing in order to have a constant composition.

It is advantageous to perform a counter-analysis on a powder sample each time that a predetermined number of recycling operations has been made, for example every 10 recycling operations, but this number is not limiting. This makes it possible to readjust the prediction of law (I) by measuring an effective content Xₙ. This is also an opportunity to verify that the difference between the measured value Xₙ and predicted average value meets condition (III).

The method can be continued until the batch of powder 16 is used up.

The method of the invention is inexpensive. Indeed, the data for the law are collected with standard manufactures and some chemical analyses during the initiation phase and the cost of occasional counter analyses is low when compared with other methods. It does not add to the cycle time. It is economic on powder and there should no longer be residual powder with this method, especially if refreshing is authorised. The invention does not require production of parts dedicated to the analysis.

The invention can provide a method for industrial monitoring and prediction of the chemical composition during manufacture and can anticipate when there is a risk of departing from the criteria for the material which can impact its properties. The invention makes it possible to monitor the chemical composition during successive manufacturings of parts, in particular aeronautical parts, from metallic powder-bed based additive manufacturing (with laser LBM/SLM or electron beam EBM).

In another embodiment, the estimation of the content X, during the operating phase can be used to determine, above all, whether the powder can be recycled as is (i.e. without mixing) or whether it should be discarded. This is not the most powder-saving version of the embodiment of the invention. However, it can be seen, with this alternative, that the invention makes it possible, above all, to make a decision on the follow-up to be given to the method.

1. A manufacturing method,
the method comprising the following steps:
extracting a sub-batch from a batch of powder, the batch having a content X₀ of a predetermined compound,
by means of the sub-batch, manufacturing parts by powder-bed based additive manufacturing until all of the sub-batch has been used; then
carrying out the following cycle a number nₘₐₓ of times:
recycling a powder from the manufacturing step and continuing the manufacturing step until all of the recycled powder has been used;
determining:
a contact area Sₙ between the powder and a fused material in the parts, accumulated from a start of the method, n designating a number of the cycle, and
a mass Mₙ of accumulated powder used since the start of the method, the recycled powder at each cycle counting as additional mass, and
measuring a content Xₙₘₐₓ of the compound in at least one of the parts manufactured during a last cycle or a test piece manufactured during the last cycle, then
calculating a quantity R such as:
$${X}_{nmax} = {X}_{0} + R * {\sum }_{n = 1}^{n = nmax} \frac{Sn}{Mn}$$
carrying out the following cycle at least once:
recycling the powder and continuing the manufacturing step until at least all of the recycled powder has been used at least once, then
determining the contact area Sₙ and the mass Mₙ of powder, and
calculating, using Sₙ, Mₙ and R, a content Xₙ of the compound in one of the parts manufactured during the cycle.

2. The method according to the preceding claim, wherein the batch is new at the start of an implementation of the method.

3. The method according to claim 1 wherein the compound is oxygen, hydrogen or nitrogen.

4. The method according to claim 1, then comprising the following steps:
determining whether the content Xₙ fulfils a predetermined condition; and
determining a follow-up to be applied to the method according to whether or not the content Xₙ fulfils the condition.

5. The method according to claim 1, then comprising the following steps:
extracting another sub-batch from the batch of powder;
producing a mixture of the other sub-batch with the powder from the manufacturing step; and
repeating the manufacturing step with the mixture.

6. The method according to claim 4 wherein the steps of claim 5 are carried out when the condition is not fulfilled.

7. The method in which the steps of claim 5 are carried out without determining beforehand whether the content X₁ fulfils a predetermined condition.

8. The method according to claim 1 wherein:
during at least some of the cycles, a content X_{n,mes} of the compound is measured in at least one of the parts during the cycle, in a test piece manufactured during the cycle or in the powder used during the cycle;
a standard deviation of the content X_{n,mes} is determined; and
during at least some of the cycles after the step of calculating R, it is determined whether the calculated content Xₙ satisfies a predetermined condition relating to the standard deviation.

9. The method according to the preceding claim, wherein it is determined whether:

|Xₙ−X_{n,moy}|=<2×σ
where:
X_{n,moy} designates an average of the content Xₙ of a plurality of cycles; and
σ is the standard deviation of the contents X_{n,mes}.

10. A facility for powder-bed based additive manufacturing, the facility comprising:
means for powder-bed based additive manufacturing, and
a control member configured to control an execution of a method, the method comprising the following steps:
extracting a sub-batch from a batch of powder, the batch having a content X₀ of a predetermined compound,
by means of the sub-batch, manufacturing parts by powder-bed based additive manufacturing until all of the sub-batch (18) has been used; then
carrying out the following cycle a number nₘₐₓ of times:
recycling a powder from the manufacturing step and continuing the manufacturing step until all of the recycled powder has been used;
determining:
a contact area Sₙ between the powder and a fused material in the parts accumulated from a start of the method, n designating a number of the cycle, and—a mass Mₙ of accumulated powder used since the start of the method, the recycled powder at each cycle counting as additional mass, and
measuring a content Xₙₘₐₓ of the compound in at least one of the parts manufactured during a last cycle or a test piece manufactured during the last cycle, then
calculating a quantity R such as:
$${X}_{nmax} = {X}_{0} + R * {\sum }_{n = 1}^{n = nmax} \frac{Sn}{Mn}$$
carrying out the following cycle at least once:
recycling the powder and continuing the manufacturing step until at least all of the recycled powder has been used at least once, then
determining the contact area Sₙ and the mass Mₙ of powder, and
calculating, using Sₙ, Mₙ and R, a content Xₙ of the compound in one of the parts manufactured during the cycle.

11. A computer program,
the program comprising code instructions configured to control an execution of a method when it is used on a computer,
the method comprising the following steps:
extracting a sub-batch from a batch of powder, the batch having a content X₀ of a predetermined compound,
by means of the sub-batch, manufacturing parts by powder-bed based additive manufacturing until all of the sub-batch has been used; then
carrying out the following cycle a number nₘₐₓ of times:
recycling a powder from the manufacturing step and continuing the manufacturing step until all of the recycled powder has been used:
determining:
a contact area Sₙ between the powder and a fused material in the parts accumulated from a start of the method, n designating a number of the cycle, and—a mass Mₙ of accumulated powder used since the start of the method, the recycled powder at each cycle counting as additional mass, and
measuring a content Xₙₘₐₓ of the compound in at least one of the parts manufactured during a last cycle or a test piece manufactured during the last cycle, then
calculating a quantity R such as:
$${X}_{nmax} = {X}_{0} + R * {\sum }_{n = 1}^{n = nmax} \frac{Sn}{Mn}$$
carrying out the following cycle at least once:
recycling the powder and continuing the manufacturing step until at least all of the recycled powder has been used at least once, then
determining the contact area Sₙ and the mass Mₙ of powder, and
calculating, using Sₙ, Mₙ and R, a content Xₙ of the compound in one of the parts manufactured during the cycle.

12. A data recording medium comprising a program according to the preceding claim in recorded form.

13. A method for providing a program according to claim 11 on a telecommunications network for the purpose of downloading it or executing it remotely.
